(19) United States
(12) Patent Application Publication
(10) Pub. No.: US 2026/0349191 A1
(43) Pub. Date: Nov. 5, 2026

(54) WAFER-LEVEL OPTICAL I/O COMPONENTS IN CO-PACKAGED OPTICAL DEVICES

(71) Applicant: Applied Materials, Inc., Santa Clara, CA (US)

(72) Inventors: Guannan Chen, Belmont, CA (US); Qing Tan, Weston, MA (US); Jinxin Fu, Fremont, CA (US)

(21) Appl. No.: 19/199,107

(22) Filed: May 5, 2025

(51) Int. Cl. G02B 6/42

(52) U.S. Cl. CPC G02B 6/4214

(57) ABSTRACT

A method is provided. The method includes aligning one or more features of a photonic integrated circuit (PIC) substrate with corresponding one or more features of a photonic substrate, performing a first bonding process to bond the PIC substrate to a first region of the photonic substrate to create a bonded substrate, performing a first growth process on the bonded substrate to form a first gap-fill layer on a second region of the photonic substrate not covered by the PIC substrate, aligning one or more optical features of a microlens array substrate with one or more corresponding optical features of the bonded substrate, and performing a final bonding process to bond the microlens array substrate to the bonded substrate to create a photonic package.

### TECHNICAL FIELD

Embodiments of the disclosure relate, in general, to a wafer-level optical I/O components in co-packaged optical devices. More specifically, the embodiments of the disclosure relate to a photonic substrate packaging configured to receive photonic components.

### BACKGROUND

Manufacturing photonic components on the same substrate is complex. Often different components of the substrate use different manufacturing processes, use different materials, and so on. Aligning all the manufacturing processes in the right order is complicated and can result in inefficient processing for the substrate.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some aspects, a method is provided for manufacturing wafer-level optical I/O components for co-packaged optical devices. The method includes aligning one or more features of a photonic integrated circuit (PIC) substrate with corresponding one or more features of a photonic substrate; performing a first bonding process to bond the PIC substrate to a first region of the photonic substrate to create a bonded substrate; performing a first growth process on the bonded substrate to form a first gap-fill layer on a second region of the photonic substrate not covered by the PIC substrate; aligning one or more optical features of a microlens array substrate with one or more corresponding optical features of the bonded substrate; and performing a final bonding process to bond the microlens array substrate to the bonded substrate to create a photonic package.

In some aspects, a photonic substrate is provided. The photonic substrate includes a plurality of photonic dies disposed on a base substrate; a plurality of photonic integrated circuit (PIC) dies that are fusion bonded to respective photonic dies of the plurality of photonic dies disposed on the base substrate; and a microlens array substrate that is fusion bonded to the plurality of PICs and the base substrate.

In some aspects, a photonic substrate is provided. The photonic substrate includes one or more photonic dies disposed on a base substrate; one or more photonic integrated circuit (PIC) dies that are fusion bonded to respective photonic dies of the one or more photonic dies; one or more electrical integrated circuit (EIC) dies that are hybrid fusion bonded to respective PIC dies of the one or more PIC dies; and a microlens array substrate that is fusion bonded to the one or more EIC dies.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 is a side profile of a fusion bonded substrate (e.g., a photonic package or on-chip embedded optical system), according to aspects of the disclosure.

FIGS. 2A-2B illustrate a workflow for manufacturing wafer-level optical I/O components in a co-packaged optical device, according to some aspects of the disclosure.

FIG. 3 is a side profile of a fusion bonded substrate, according to aspects of the disclosure.

FIG. 4 illustrates a workflow for manufacturing wafer-level optical I/O components in a co-packaged optical device, according to some aspects of the disclosure.

FIG. 5 is a side profile of a fusion bonded substrate, according to aspects of the disclosure.

FIG. 6 illustrates a workflow for manufacturing wafer-level optical I/O components in a co-packaged optical device, according to some aspects of the disclosure.

FIG. 7 illustrates a workflow for manufacturing wafer-level optical I/O components in a co-packaged optical device, according to some aspects of the disclosure.

FIG. 8 illustrates a workflow for manufacturing wafer-level optical I/O components in a co-packaged optical device, according to some aspects of the disclosure.

FIG. 9 is a diagram of cross-sectional view of an example system, according to some aspects of the disclosure.

### DETAILED DESCRIPTION

Co-packaged optics (CPO) and optical interconnects provide increases in data rates and signal bandwidth, which is useful for hyperscaler data centers used for artificial intelligence generated content (AIGC) model training and inferencing such as with large language model (LLM). Alignment of optical components for manufacturing photonic packages including photonic integrated circuits (PICs) and corresponding photonic components can be challenging. As the size of optical components gets smaller, alignment tolerances shrink as well.

Optical I/O coupling from and to a photonic integrated circuit (PIC) chip with low loss is useful for CPOs. Some PIC I/O coupling methods include grating coupling and edge coupling.

One way that photonic devices are aligned is through active alignment. In active alignment, a light source shines through the optical paths of respective components. The position of the light source is used to determine where to place an optical component for maximum optical transmission efficiency. However, active alignment is relatively slow and can significantly reduce the potential throughput for a manufacturing line. As throughput decreases, the cost to produce each component on the manufacturing line increases.

Additionally, coupling methods for PICs often rely on grating coupling and edge coupling. Grating coupling can be sensitive to polarization and have an overall lower efficiency and narrow bandwidth, while edge coupling presents challenges with available shoreline and optical connection density.

Aspects of the present disclosure address these and other challenges by using substrate-processing methods to align photonic components. In embodiments, a method for I/O coupling uses a wafer-processing approach to create an on-chip turning element to redirect light emitting from the end of a waveguide (WG) from in-plane to out-of-plane. This method uses a microlens to collimate the diverged light to relay optics and eventually into an optical fiber and/or optical component. Accurate alignment of the microlens assembly and of PICs to a photonic substrate increases efficiency and reduces transmission loss.

Photonic components can be fusion bonded to a substrate. Substrate fabrication process, since it is photo lithography based process, may have better control on dimensional tolerance than typical assembly process such as pick-and-place, or the like. Active alignment process, on the other hand, while can delivery good optical alignment, are generally time consuming, and expensive. These higher tolerances allow for a potentially improved alignment of the photonic components if the alignment can be performed within the substrate processes. After a photonic component, such as a PIC, or an electrical integrated circuit (EIC) are fusion bonded to the substrate, gap-fill material can be grown around the photonic component and/or EIC, and the substrate can be further processed with typical substrate processes. This series of processes can be repeated, and layers of integrated circuits (ICs) such as PICs and/or EICs can be stacked up on top of each other with one or more gap-fill layers grown around each fusion bonded IC to create a new layer. Once all ICs have been attached to the substrate, a microlens array can be fusion bonded to the top of the substrate. By bonding the microlens array as a substrate (e.g., a wafer) to another substrate (e.g., another wafer), only one alignment process is performed to align the microlens array with the integrated photonic turning elements of the photonic substrate.

Advantages of the present disclosure include improved alignment of photonic components, such as microlens arrays, with integrated turning elements. Additionally, alignment of a full substrate (e.g., wafer) of microlenses with integrated turning elements in a base substrate (e.g., wafer) does not rely on active alignment, which can improve manufacturing throughput, thus reducing the cost to produce each unit.

As used herein fusion bonding can refer to a semiconductor manufacturing process that permanently joins two semiconductor substrates (e.g., dielectric substrates) without adhesives or solder. The process begins by bringing two substrate surfaces into close contact, where weak bonds form due to intermolecular forces (e.g., Van der Waals forces, hydrogen bonds, etc.). A high-temperature annealing step, usually between approximately 200 °C and 1200 °C, causes atoms at the interface to diffuse, creating strong atomic bonds. The quality of the bond depends on precise alignment, surface flatness, and cleanliness, as particles or roughness can lead to defects.

As used herein, hybrid fusion bonding can refer to a semiconductor manufacturing process that incorporates metallic structures into the fusion bonding process. Hybrid fusion bonding incorporates direct conductor-to-conductor and dielectric-to-dielectric connections. Similar to fusion bonding described above, two substrates surfaces are brought into close contact, where weak bonds form due to intermolecular forces. A high-temperature annealing step bonds the two substrates together, creating high-conductivity interconnects. In some embodiments, fusion bonding and/or hybrid fusion bonding may create a near-seamless bond between the substrates. The result can be a high-strength bond with minimal electrical resistance and/or parasitic effects, robust electrical pathways, and high mechanical stability.

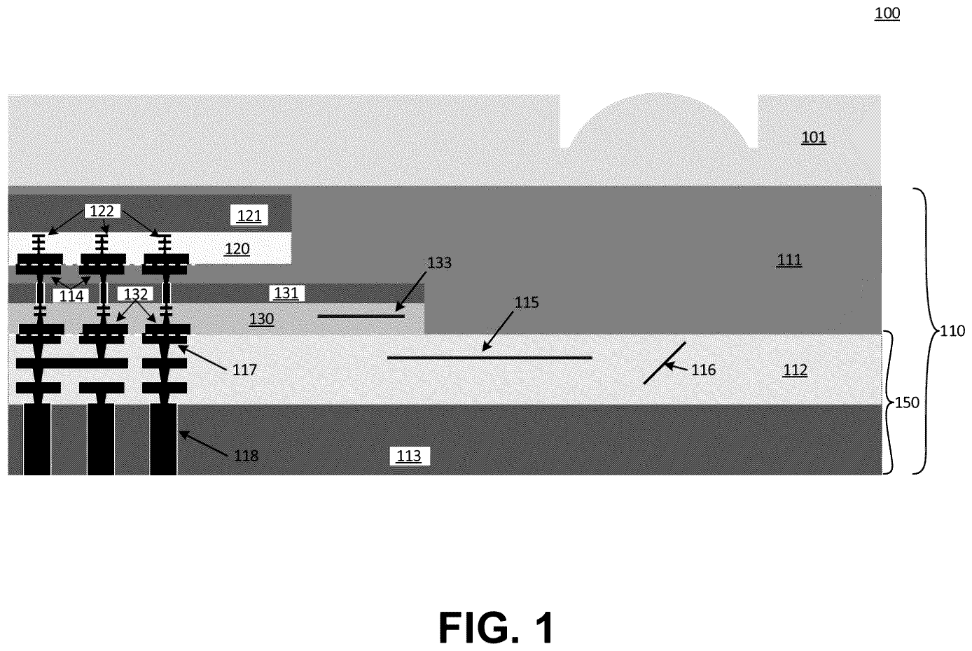

FIG. 1 is a side profile of a fusion bonded substrate 100 (e.g., a photonic package or on-chip embedded optical system), according to aspects of the disclosure. The fusion bonded substrate 100 includes a microlens array 101 that is fusion bonded to a bonded substrate 110. The bonded substrate 110 includes an electrical integrated circuit (EIC) 120 and a photonic integrated circuit (PIC) 130, where the PIC 130 is bonded to a photonic substrate 150 including a base layer 113 and a redistribution layer 112 (also referred to as a cladding layer), and the EIC 120 is bonded to the PIC 130. The bonded substrate 110 further includes a gap-fill layer 111 on regions of the redistribution layer 112 and on regions of the PIC 130 in embodiments. It is noted that the illustrated fusion bonded substrate 100 may not be dimensionally accurate, but rather is used to functionally illustrate the various layers in the fusion bonded substrate 100. In particular, the height of the various layers may be compressed or expanded in order to show all layers in the same figure with relevant details.

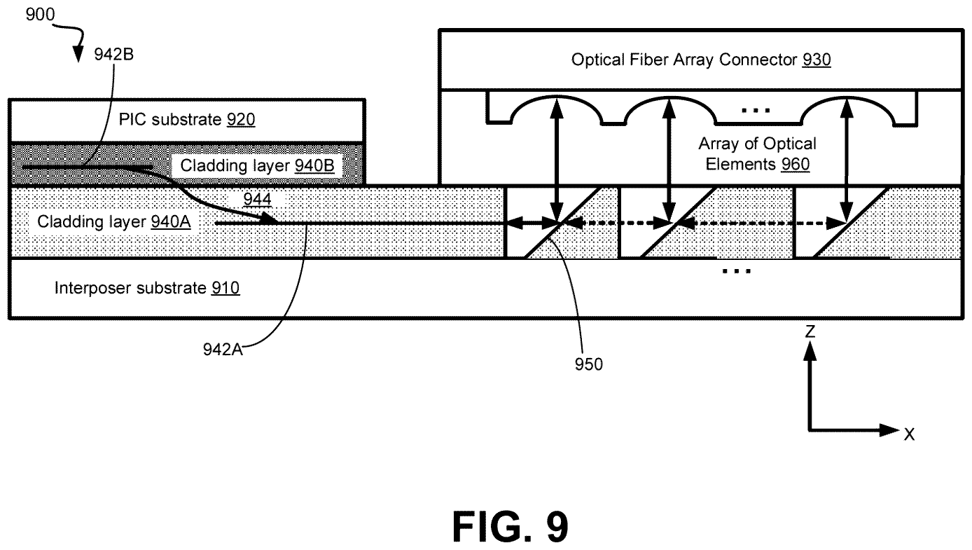

The microlens array 101 can include multiple microlenses arranged in a 2-dimensional array in a substrate. In some embodiments, the microlens array 101 is arranged on a substrate that is the same size as the bonded substrate 110. For example, if the bonded substrate 110 comprises base layer 113 formed from a wafer with a 300-millimeter (mm) diameter, the microlens array 101 can be arranged on a similarly sized wafer (e.g., a wafer with an approximate 300-mm diameter). This allows for a single alignment between the microlens array 101 and the bonded substrate 110. In some embodiments, performing a single alignment operation by aligning the microlens array 101 with the bonded substrate can reduce a manufacturing complexity and duration. For example, alignment between the two substrates may be achieved without active alignment, which uses light sources to align optical paths in photonic components. Additional details regarding the function of microlenses in a PIC are described below with reference to FIG. 9.

The bonded substrate 110 includes the EIC 120 and PIC 130. The EIC 120 and PIC 130 are embedded in and/or surrounded by gap-fill layer 111 in embodiments. During manufacturing of the bonded substrate 110, the PIC 130 is fusion bonded to the redistribution layer 112. A gap-filling process is performed to produce a portion of the gap-fill layer 111. In embodiments, the gap-fill layer comprises one or more optically transparent materials, such as silicon oxide (SiO), silicon dioxide (SiO₂), or the like. Subsequently, the EIC 120 is fusion bonded to the PIC 130, and another gap-fill process is performed to produce the remaining portion of the gap-fill layer 111. In some embodiments, the remaining portion of the gap-fill layer 111 is formed from the same material as the first portion of the gap fill layer 111. Alternatively, a different material may be used to form the remaining portion of the gap fill layer 111. In some embodiments, the PIC 130 can be fusion bonded to the redistribution layer 112, and the EIC 120 can be fusion bonded to the PIC 130, and then a single gap-fill process is performed to produce the gap-fill layer 111 in the same process. In some embodiments, the EIC 120 can be fusion bonded to the PIC 130 prior to fusion-bonding the PIC 130 to the redistribution layer 112.

The EIC 120 includes an EIC substrate 121 and conductive vias/traces 122 (also referred to herein as “electrical features”). The EIC 120 can include one or more electrical components that are designed to integrate with one or more photonic components of the PIC 130. In some embodiments, electrical components in the EIC 120 can include power delivery components, signal processing components, signal generation components, or the like. The EIC 120 can include electrical connections that are configured to electrically couple with corresponding electrical features in the redistribution layer 112. In some embodiments, the EIC 120 can include electrical connections that are configured to electrically couple with corresponding electrical connections in a corresponding PIC (such as PIC 130).

The PIC 130 includes a PIC substrate 131, conductive vias/traces 132, and an optical path 133, illustrated here as a waveguide (e.g., a PIC waveguide). The conductive vias/traces 132 of the PIC 130 can be configured to align with corresponding electrical connections in the EIC 120 (e.g., conductive vias/traces 122). The PIC 130 can include one or more photonic components that are designed to transmit, receive, and/or process an optical signal. In some embodiments, the photonic components are arranged in or included in an optical path 133. In some embodiments, the photonic components can include waveguides, gratings, turning elements, optical signal generation components, optical signal detection components, optical processing components, or the like. As illustrated, the optical path 133 includes a waveguide that evanescently couples with a waveguide in an optical path 115 of the redistribution layer 112 (e.g., a photonic waveguide). In some embodiments, the waveguide in the optical path 133 is configured to optically couple with one or more corresponding waveguides in the optical path 115 of the redistribution layer 112 (e.g., a respective photonic waveguide). In other embodiments, a turning element in the photonic substrate 150 may redirect an optical signal from a horizontal plane to a vertical plane for coupling to the PIC 130.

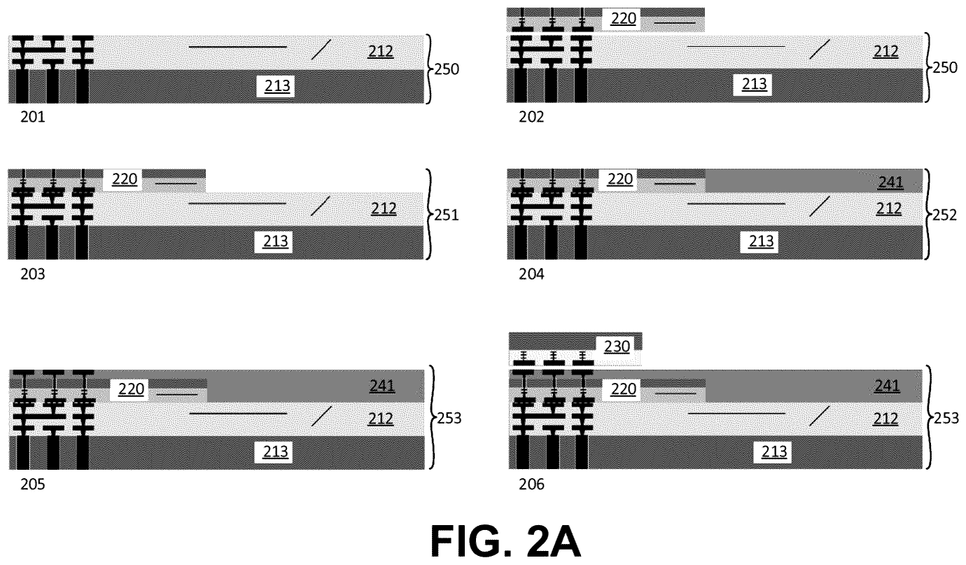

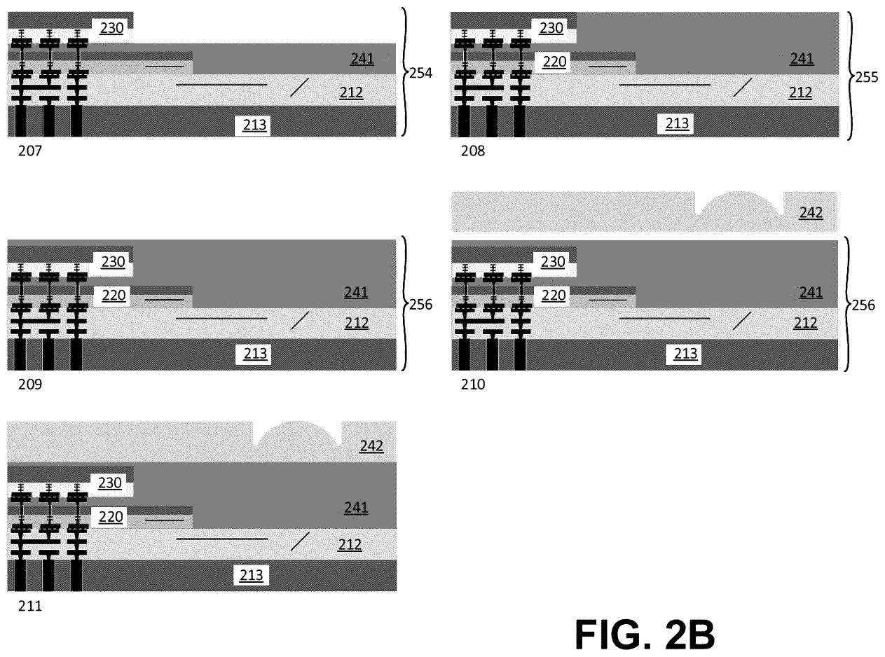

Although a single EIC 120 and PIC 130 pair are illustrated in this side-profile view, multiple EICs 120 and PICs 130 can be included in the bonded substrate 110 (e.g., as a 2-dimensional array, that may be associated with the 2-dimensional layout of the microlens array 101). In some embodiments, EICs 120 and PICs 130 can be bonded as individual units (e.g., dies). For example, EICs 120 and PICs 130 may be placed on the photonic substrate 150 containing the redistribution layer 112 and the base layer 113 using pick-and-place machines and/or techniques. In some embodiments, EICs 120 and PICs 130 can be bonded as substrates containing multiple EICs 120 and/or PICs 130. For example, a PIC substrate may include multiple PIC dies, and the PIC substrate comprising the multiple PIC dies may be bonded to the photonic substrate 150. Similarly, an EIC substrate including multiple EIC dies may be bonded to the PIC substrate and/or to the bonded substrate that includes the PICs bonded to the photonic substrate 150. n some embodiments, a substrate can include an array or set of EICs 120 and/or PICs 130. In some embodiments, a substrate containing an array of EICs 120 and/or PICs 130 can be fusion bonded to a top surface of the redistribution layer 112. Additional details regarding the method for attaching the EIC 120 and PIC 130 to the bonded substrate 110 are described with reference to FIGS. 2A-2B, below.

The redistribution layer 112 includes the optical path 115 (illustrated here with a waveguide), a photonic turning element 116, and conductive vias/traces 117. In some embodiments, at least a portion of the redistribution layer 112 includes optically transparent materials. In some embodiments, the redistribution layer 112 is formed from an oxide material. For example, the redistribution layer 112 can be formed from SiO₂. More specifically, the redistribution layer 112 can be a thick cladding layer. The redistribution layer 112 can have any suitable thickness. In some embodiments, the thickness of the redistribution layer 112 ranges from about 5 μm to about 20 μm.

The redistribution layer 112 can include multiple (e.g., an array of) small trenches. For example, a trench can be a micro-trench. Each trench of the redistribution layer 112 can have a turning element 116 formed therein. Each turning element 116 may include a reflective material (e.g., metal reflector) formed within a respective trench of the redistribution layer 112 (e.g., formed on an angled trench wall of a respective trench). In some embodiments, the turning element 116 is a mirror. For example, the turning element 116 can be an angled mirror formed along an angled sidewall of its corresponding trench.

Multiple parallel inner cores, including optical path 115, can be formed within the redistribution layer 112 to form multiple parallel waveguides, and each turning element can be coupled (e.g., edge coupled) to a respective inner core of the multiple parallel inner cores (e.g., the turning element 116 coupled to the optical path 115). The multiple parallel inner cores, including the optical path 115, can be formed from any suitable material. The multiple parallel inner cores, including the optical path 115, can have a higher refractive index than the redistribution layer 112 to form effective optical waveguides. In some embodiments, the optical path 115 is formed from Si₃N₄.

In some embodiments, when the PIC 130 is aligned with the photonic substrate 150 containing the redistribution layer 112, the conductive vias/traces 132 of the PIC are aligned with the conductive vias/traces 117 of the redistribution layer 112. In some embodiments, the redistribution layer 112 includes multiple waveguides in the optical path 115. As illustrated, the optical path 115 includes a waveguide that is configured to evanescently couple with a waveguide in the optical path 133 of the PIC 130. As illustrated, the optical path 115 (e.g., waveguide(s)) is coupled with the photonic turning element 116. The photonic turning element 116 can be designed to reflect an optical signal exiting the optical path 115 up to a respective microlens of the microlens array 101. In some embodiments, the photonic turning element 116 is a mirror (or similar) such that an incident angle of the optical signal exiting the optical path 115 is approximately 45 degrees. In some embodiments, the photonic turning element 116 has an angle that is approximately 45 degrees from a horizontal reference. Other angles may also be used.

The base layer 113 includes conductive vias/traces 118 that connect with the conductive vias/traces 117 of the redistribution layer 112. In some embodiments, the base layer 113 can include through-silicon vias (TSVs).

The gap-fill layer 111 also includes conductive vias/traces 114 in embodiments. In some embodiments, the conductive vias/traces 114 are added during the process to produce the gap-fill layer 111. In alternative embodiments, the conductive vias/traces 114 are added to the gap-fill layer 111 using an etch and deposition process after the gap-fill material has been deposited. The conductive vias/traces 114 are aligned with the conductive vias/traces 132 of the PIC 130 and are configured to align with corresponding conductive vias/traces 122 of the EIC 120. In some embodiments, at least a portion of the gap-fill layer 111 includes optically transparent materials.

In some embodiments, conductive pads are coupled to a top surface of one or more of the conductive vias/traces 114, 117. These conductive pads increase the tolerance for aligning electrical connections between the various layers of the fusion bonded substrate 100. In some embodiments, after a process to deposit a portion of the gap-fill layer 111 onto the PIC 130, a process can be performed to expose the conductive vias/traces 114, and fill in a small area (e.g., conductive pad) with conductive material. In some embodiments, the conductive vias/traces 114, 117, 118 can include one or more conductive materials, such as copper, aluminum, platinum, gold, or the like.

Additional details regarding the processes used to produce the fusion bonded substrate 100 are described below with reference to FIGS. 2A-2B and FIGS. 7-8.

FIGS. 2A-2B illustrate a workflow 200 for manufacturing wafer-level optical I/O components in a co-packaged optical device, according to some aspects of the disclosure. The workflow 200 may be performed using a series of manufacturing machines, such as semiconductor manufacturing machines. Examples of machines include etch reactors, deposition chambers, photolithography devices, metrology devices, bonding machines, and so on. The manufacturing machines may include hardware (e.g., one or more processing device(s), circuitry, dedicated logic, programmable logic, microcode, hardware of a device, integrated circuit, etc.), software (e.g., instructions run or executed on a processing device), or a combination thereof that cause the manufacturing machines to execute process recipes to perform operations that cause the co-packaged optical device to be manufactured. In one example, the workflow 200 is performed according to instructions from one or more controllers in a manufacturing environment. For example, the workflow 200 may be performed by multiple controllers, each associated with a respective manufacturing environment. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other workflows are possible.

In some embodiments, the workflow 200 describes a series of processes used to produce the fusion bonded substrate 100 (e.g., photonic package or co-packaged optical device) of FIG. 1. The same features of the fusion bonded substrate 100 are illustrated in various processes of the workflow 200. Thus, descriptions of the functionality of elements or layers illustrated in the various processes of the workflow 200 can be found in the description above accompanying FIG. 1.

At process 201, an initial photonic substrate 250 is prepared for a fusion bonding process. The initial photonic substrate 250 can include a redistribution layer 212 and a base layer 213, such as redistribution layer 112 and base layer 113 of FIG. 1, respectively. In some embodiments, the process 201 includes a flattening operation (e.g., such as chemical mechanical planarization (CMP)) to create a uniform top surface of the initial photonic substrate 250. In some embodiments, the top surface of the initial photonic substrate 250 is cleaned during the process 201, immediately prior to the process 202. In some embodiments, the initial photonic substrate 250 includes one or more photonic dies (e.g., photonic components) disposed onto a base substrate.

At process 202, an integrated circuit (IC), here illustrated as a photonic integrated circuit (PIC 220) is aligned with the initial photonic substrate 250. In some embodiments features of the PIC 220 are aligned with corresponding features of the initial photonic substrate 250. For example, the conductive vias/traces of the PIC 220 can be aligned with corresponding conductive vias/traces of the initial photonic substrate 250. In some embodiments, one or more alignment features can be manufactured on the PIC 220 and/or the initial photonic substrate 250. The alignment features can be used to align the PIC 220 with the initial photonic substrate 250. In some embodiments, the top surface of the initial photonic substrate 250 is cleaned during the process 202, immediately prior to the process 203. This cleaning can improve the quality of the fusion bond created during the process 203.

At process 203, the IC (here a PIC 220) is placed on the top surface of the initial photonic substrate 250 and fusion bonded to the initial photonic substrate 250. In some embodiments, the fusion bond is a hybrid fusion bond (i.e., a fusion bond which allows conductive materials to bond to other conductive materials and semiconductive materials to bond to semiconductive materials). In some embodiments, the fusion bond creates a uniform or near-uniform material at the bonding surface between the bonded components (e.g., the conductive materials or the semiconductive materials). In some embodiments, the top surface of the initial photonic substrate 250 is cleaned during the process 203, immediately prior to the process 204.

At process 204, a gap-fill material is deposited onto the bonded substrate 251 (e.g., the initial photonic substrate 250 with the now-bonded PIC 220). The gap-fill material is formed to be coplanar with the PIC 220. A deposition process may form the gap-fill layer 241 over exposed regions of the initial photonic substrate 251 and over the PIC 220. For example, deposition processes may include one or more of chemical vapor deposition (CVD), physical vapor deposition (PVD), or atomic layer deposition (ALD).

After the gap-fill material has reached a sufficient height, the bonded substrate comprising the PIC 220 and the photonic substrate is flattened to create a uniform top surface (e.g., via a CMP process). In some embodiments, the sufficient height of the gap-fill layer 241 is determined by a height of the PIC 220. That is, gap-fill material is deposited onto the bonded substrate until the bonded substrate can be polished to have a uniform top surface where the top surface of the gap-fill layer 241 is coplanar with a top surface of the PIC 220. In some embodiments, the top surface of the uniform bonded substrate is cleaned during the process 204, immediately prior to the process 205.

At process 205, the uniform bonded substrate 252 (e.g., the bonded substrate having a uniform top surface) is prepared for a second fusion bonding process. In some embodiments, a thin layer of material can be deposited onto the uniform bonded substrate. The thin layer of material illustrated at process 205 can be the same as or similar to the material used for the gap-fill process at the process 204. In some embodiments, the thin layer of material is applied to the uniform bonded substrate in a way that facilitates the formation of a strong fusion bond when the next IC is fusion bonded to the uniform bonded substrate at the process 207 of FIG. 2B. In one embodiment, the material is a semiconductor material, such as silicon oxide (SiO), silicon dioxide (SiO₂), or silicon nitride (SiN). In some embodiments, the thin layer of material is applied using one or more of CVD, PVD, or ALD processes.

In some embodiments, and as illustrated, the process 205 can include a formation of conductive vias/traces and/or pads in the thin layer of material that expose conductive vias/traces of, or connected to the PIC 220. In some embodiments, the thin layer of material is first deposited, then corresponding vias/traces and/or pads are etched into the thin layer, and conductive material is then deposited into the etched vias/traces and/or pads. In some embodiments, multiple layers of the material are deposited, patterned, etched to form holes/channels, and then further processed to fill the holes/channels and form the vias/traces and/or pads therein. For example, a first layer may be deposited and have vias formed therein, and a second layer may then be deposited and have pads formed therein, wherein the pads couple to the vias. In some embodiments, the top surface of the prepped bonded substrate is cleaned during the process 205, immediately prior to the process 206.

At process 206, another IC, here illustrated as an electrical integrated circuit (EIC 230), is aligned with the prepped bonded substrate 253 (e.g., the uniform bonded substrate having a top surface prepped for fusion bonding), similar to the process 201 for the PIC 220. In some embodiments, one or more features of the EIC 230 are aligned with corresponding one or more features of the prepped bonded substrate (e.g., with features of the PIC 220). For example, the conductive vias/traces of the EIC 230 can be aligned with corresponding conductive vias/traces of the prepped bonded substrate. In some embodiments, one or more alignment features can be manufactured on the EIC 230 and/or the prepped bonded substrate. The alignment features can be used to align the EIC 230 with the prepped bonded substrate. In some embodiments, the top surface of the prepped bonded substrate is cleaned during the process 206, immediately prior to the process 207. This cleaning can improve the quality of the fusion bond created during the process 207.

At process 207 (illustrated in FIG. 2B), the IC, here the EIC 230, is placed on the top surface of the prepped bonded substrate 253 and fusion bonded to the prepped bonded substrate, similar to the process 203 for the PIC 220. In some embodiments, the fusion bond is a hybrid fusion bond, which as described above allows conductive materials and semiconductor materials to bond to like materials. In some embodiments, the fusion bond creates a uniform or near-uniform material at the bonding surface between the bonded components, as described above. In some embodiments, the top surface of the double-bonded substrate is cleaned during the process 207, immediately prior to the process 208.

At process 208, a gap-fill material is deposited onto the double-bonded substrate 254 (e.g., the prepped bonded substrate with the now-bonded EIC 230, or updated bonded substrate), similar to the process 204 with the PIC 220. The gap-fill material is formed to be coplanar with the EIC 230. A deposition process may form the gap-fill layer 241 over exposed regions of the double-bonded substrate and over the EIC 230. After the gap-fill material has reached a sufficient height, the double-bonded substrate including the EIC 230, the PIC 220, and the photonic substrate is flattened to create a uniform top surface (e.g., via a CMP process). In some embodiments, the sufficient height of the gap-fill layer 241 is determined by a height of the EIC 230. That is, gap-fill material is deposited onto the bonded substrate until the bonded substrate can be polished to have a uniform top surface where the top surface of the gap-fill layer 241 is coplanar with a top surface of the EIC 230. In some embodiments, the top surface of the uniform double-bonded substrate is cleaned during the process 204, immediately prior to the process 205.

At process 209, the uniform double-bonded substrate 255 (e.g., the double-bonded substrate with bonded PIC 220 and bonded EIC 230 having a uniform top surface) is prepared for a third fusion bonding process, similar to the process 205 of FIG. 2A. In some embodiments, a thin layer of material can be deposited onto the uniform bonded substrate. The thin layer of material illustrated at process 209 can be the same as or similar to the material used for the gap-fill process at the process 208. In some embodiments, the thin layer of material is applied to the uniform bonded substrate in a way that facilitates the formation of a strong fusion bond when the next IC is fusion bonded to the uniform bonded substrate at the process 211. In some embodiments, the top surface of the prepped double-bonded substrate is cleaned during the process 209, immediately prior to the process 210.

At process 210, a passive photonic component, here illustrated as a microlens array 242, is aligned with the prepped double-bonded substrate 256 (e.g., the uniform double-bonded substrate having a top surface prepped for fusion bonding), similar to the process 201 for the PIC 220 and the process 206 for the EIC 230. In some embodiments, one or more features of the microlens array 242 (or other passive photonic component) are aligned with corresponding one or more features of the prepped double-bonded substrate. For example, lenses of the microlenses array may be aligned with turning elements in the bonded substrate. The gap-fill layer 241 may be transparent to the wavelengths of light that are transmitted between the lenses and the turning element in embodiments. In some embodiments, one or more alignment features can be manufactured on the substrate containing the microlens array 242 and/or the prepped double-bonded substrate. The alignment features can be used to align the microlens array 242 with the prepped double-bonded substrate. In some embodiments, the top surface of the prepped double-bonded substrate is cleaned during the process 210, immediately prior to the process 211. This cleaning can improve the quality of the fusion bond created during the process 211.

At process 211, the passive photonic component, here the microlens array 242, is placed on the top surface of the prepped double-bonded substrate 256 and fusion bonded to the prepped double-bonded substrate, similar to the process 203 of FIG. 2A for the PIC 220, or the process 207 for the EIC 230. In some embodiments, the fusion bond creates a uniform or near-uniform material at the bonding surface between the bonded components, as described above. In some embodiments, after the process 211, the triple bonded substrate (e.g., the prepped double bonded substrate and now-bonded microlens array 242) can be prepared for packaging in an optical device or optical component.

In embodiments, the microlens array 242 is formed in or on a substrate, and/or is itself a substrate, that may have similar x and y dimensions to those of the bonded substrate. The bonded substrate may include dies for multiple photonic devices, and the microlens array 242 may include a series of microlenses and/or sub-arrays, each to be paired with turning elements of a photonic device. In embodiments, a wafer-to-wafer bonding process is performed to bond the microlens array 242 to the bonded substrate. In some embodiments, dicing may be performed after the bonding process to separate multiple dies of the bonded substrate. These may then be packaged into individual photonic devices in some embodiments.

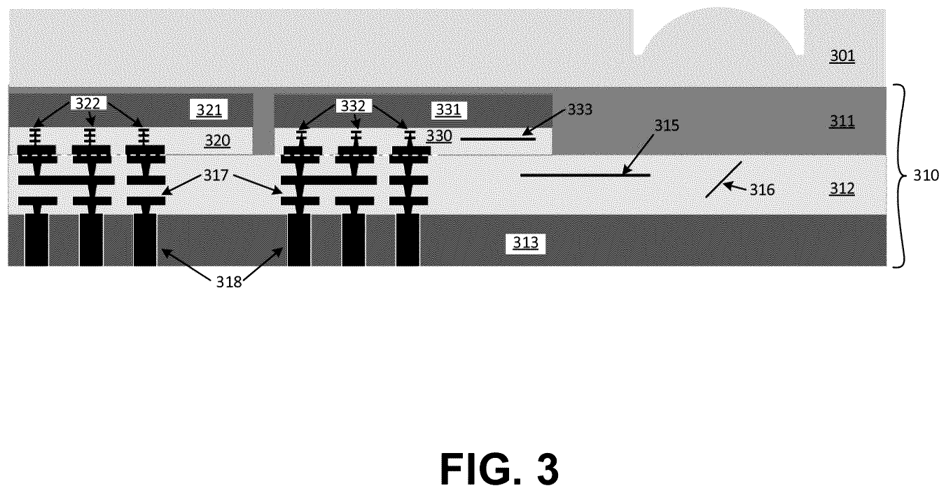

FIG. 3 is a side profile of a fusion bonded substrate 300, according to aspects of the disclosure. The substrate 300 includes a microlens array 301 that is fusion bonded to a bonded substrate 310. The bonded substrate includes an electrical integrated circuit (EIC) 320 and a photonic integrated circuit (PIC) 330 embedded in gap-fill layer 311, a redistribution layer 312, and a base layer 313. It is noted that the illustrated fusion bonded substrate 300 may not be dimensionally accurate, but rather is used to functionally illustrate the various layers in the fusion bonded substrate 300. In particular, the height of the various layers may be compressed or expanded in order to show all layers in the same figure with relevant details.

The microlens array 301 can be the same as or similar to the microlens array 101 of FIG. 1. The redistribution layer 312 includes an optical path 315, photonic turning element 316, conductive vias/traces 317, and can be the same as or similar to the redistribution layer 112 of FIG. 1. The base layer 313 includes conductive vias/traces 318, and can be the same as or similar to the base layer 113 of FIG. 1.

The gap-fill layer 311 can be the same as or similar to the gap-fill layer 311 of FIG. 1, except that the EIC 320 and PIC 330 are placed in a horizontal configuration as opposed to the vertical configuration illustrated with reference to FIG. 1. In such embodiments, the EIC 320 and the PIC 330 can be fusion bonded to the redistribution layer 312 in alignment with corresponding conductive vias/traces 317, as illustrated. The gap-fill layer 311 can subsequently be grown on top of and around the fusion bonded EIC 320 and PIC 330. The EIC 320 and PIC 330 can be the same as or similar to the EIC 120 and PIC 130 described above with reference to FIG. 1. The EIC 320 can include the EIC substrate 321, and conductive vias/traces 322, and can include the PIC substrate 331, conductive vias/traces 332, and an optical path 333.

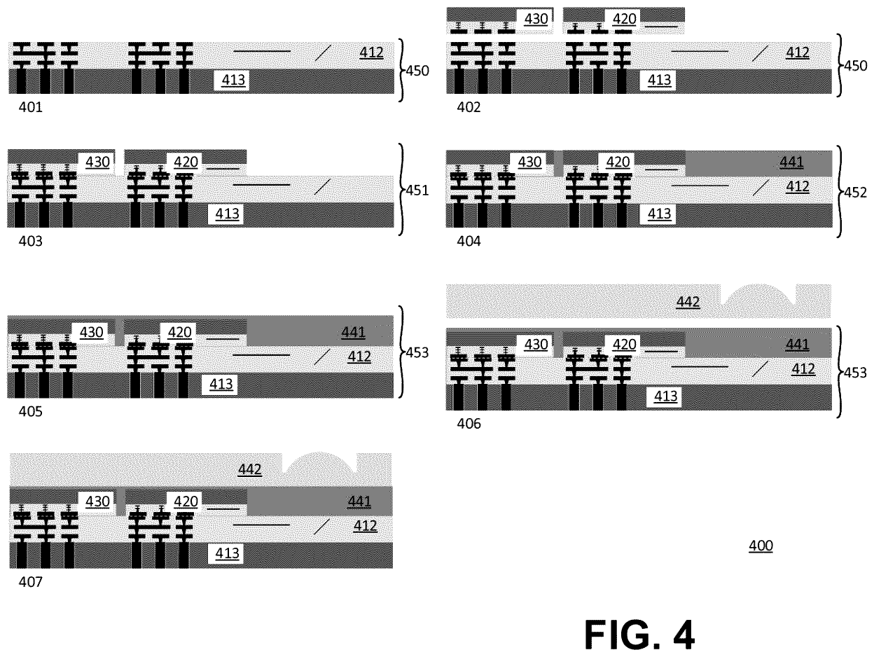

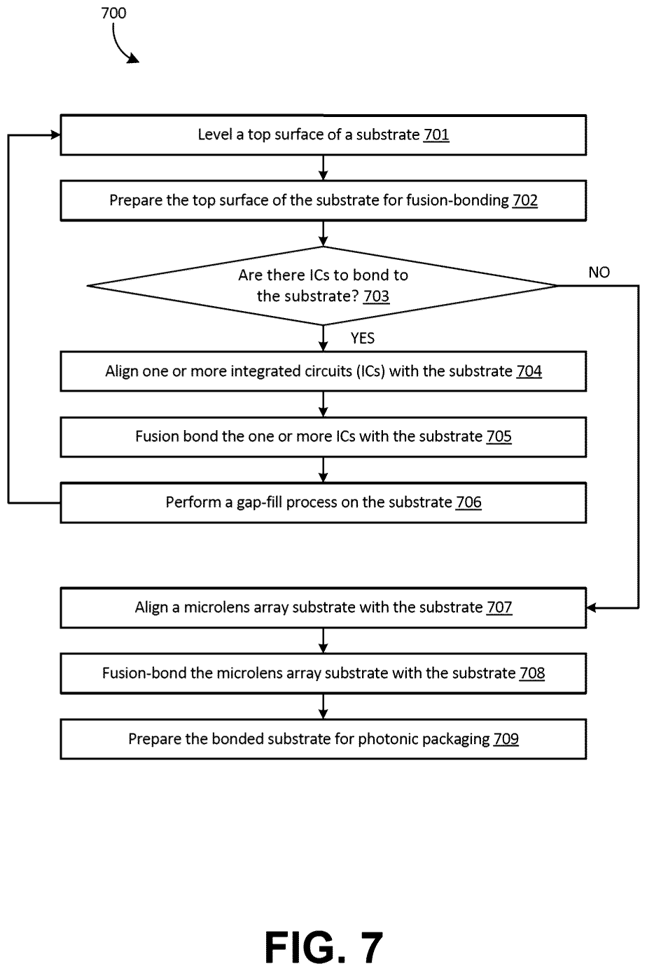

Additional details regarding the processes used to produce the fusion bonded substrate 300 are described below with reference to FIG. 4 and FIG. 7.

FIG. 4 illustrates a workflow 400 for manufacturing wafer-level optical I/O components in a co-packaged optical device, according to some aspects of the disclosure. The workflow 400 may be performed using a series of manufacturing machines, such as semiconductor manufacturing machines. Examples of machines include etch reactors, deposition chambers, photolithography devices, metrology devices, bonding machines, and so on. The manufacturing machines may include hardware (e.g., one or more processing device(s), circuitry, dedicated logic, programmable logic, microcode, hardware of a device, integrated circuit, etc.), software (e.g., instructions run or executed on a processing device), or a combination thereof that cause the manufacturing machines to execute process recipes to perform operations that cause the co-packaged optical device to be manufactured. In one example, the workflow 400 is performed according to instructions from one or more controllers in a manufacturing environment. For example, the workflow 400 may be performed by multiple controllers, each associated with a respective manufacturing environment. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other workflows are possible.

Individual processes in the workflow 400 can be similar to respective processes performed in the workflow 200 described with reference to FIG. 2. In some embodiments, the workflow 400 describes a series of processes used to produce the fusion bonded substrate 300 (e.g., photonic package or co-packaged optical device) of FIG. 3. The same features of the fusion bonded substrate 300 are illustrated in various processes of the workflow 400. Thus, descriptions of the functionality of elements or layers illustrated in the various processes of the workflow 400 can be found in the description above accompanying FIG. 3.

At process 401, an initial photonic substrate 450 is prepared for a fusion bonding process. The initial photonic substrate 450 can include a redistribution layer 412 and a base layer 413, such as redistribution layer 312 and base layer 313 of FIG. 3, respectively. In some embodiments, the process 401 includes a flattening operation (e.g., such as a CMP operation) to create a uniform top surface of the initial photonic substrate 450. In some embodiments, the top surface of the initial photonic substrate 450 is cleaned during the process 401, immediately prior to the process 402.

At process 402, multiple integrated circuits (ICs), here illustrated as a photonic illustrated circuit (PIC 420) and an electric integrated circuit (EIC 430) are aligned with the initial photonic substrate 450. In some embodiments features of each IC are aligned with corresponding features of the initial photonic substrate 450. For example, the conductive vias/traces of each IC can be aligned with corresponding conductive vias/traces of the initial photonic substrate 450. In some embodiments, one or more alignment features can be manufactured on each IC and/or the initial photonic substrate 450. The alignment features can be used to align each IC with the initial photonic substrate 450. In some embodiments, the top surface of the initial photonic substrate 450 is cleaned during the process 402, immediately prior to the process 403. This cleaning can improve the quality of the fusion bond created during the process 403.

At process 403, the ICs are placed on the top surface of the initial photonic substrate 450 and fusion bonded to the initial photonic substrate 450. In some embodiments, the fusion bond is a hybrid fusion bond (i.e., a fusion bond which allows conductive materials to bond to other conductive materials and semiconductive materials to bond to semiconductive materials). In some embodiments, the fusion bond creates a uniform or near-uniform material at the bonding surface between the bonded components (e.g., the conductive materials or the semi-conductive materials). In some embodiments, the top surface of the initial photonic substrate 450 is cleaned during the process 403, immediately prior to the process 404.

At process 404, a gap-fill material is deposited onto the bonded substrate 451 (e.g., the initial photonic substrate 450 with the now-bonded ICs). The gap-fill material is formed to be coplanar with the ICs. A deposition process may form the gap fill layer 441 over exposed regions of the initial photonic substrate 450, the PIC 420, and the EIC 430. After the gap-fill material has reached a sufficient height, the bonded substrate including the PIC 420, the EIC 430, and the photonic substrate, is flattened to create a uniform top surface (e.g., via a CMP process). In some embodiments, the sufficient height of the gap fill layer 441 is determined by a height of the taller of the bonded ICs. That is, gap-fill material is deposited onto the bonded substrate until the bonded substrate can be polished to have a uniform top surface where the top surface of the gap fill layer 441 is coplanar with a top surface of the taller of the bonded ICs (e.g., one or more of the PIC 420 or the EIC 430). In some embodiments, the top surface of the uniform bonded substrate is cleaned during the process 404, immediately prior to the process 405.

At process 405, the uniform bonded substrate 452 (e.g., the bonded substrate 451 having a uniform top surface) is prepared for a second fusion bonding process. In some embodiments, a thin layer of material can be deposited onto the uniform bonded substrate. The thin layer of material illustrated at process 405 can be the same as or similar to the material used for the gap-fill process at the process 404. In some embodiments, the thin layer of material is applied to the uniform bonded substrate in a way that facilitates the formation of a strong fusion bond when the passive photonic component is bonded to the uniform bonded substrate at the process 407. In some embodiments, the top surface of the prepped bonded substrate is cleaned during the process 405, immediately prior to the process 406. In one embodiment, the material is a semiconductor material.

At process 406, a passive photonic component, here illustrated as a microlens array 442, is aligned with the prepped bonded substrate 453 (e.g., the uniform bonded substrate 452 having a top surface prepped for fusion bonding), similar to the process 401 for the ICs. In some embodiments, one or more features of the microlens array 442 (or other passive photonic component) are aligned with corresponding one or more features of the prepped bonded substrate. For example, lenses of the microlenses array may be aligned with turning elements in the bonded substrate. The gap fill layer 441 may be transparent to the wavelengths of light that are transmitted between the lenses and the turning element in embodiments. In some embodiments, one or more alignment features can be manufactured on the substrate containing the microlens array 442 and/or the prepped bonded substrate. The alignment features can be used to align the microlens array 442 with the prepped bonded substrate. In some embodiments, the top surface of the prepped bonded substrate is cleaned during the process 406, immediately prior to the process 407. This cleaning can improve the quality of the fusion bond created during the process 407.

At process 407, the passive photonic component, here the microlens array 442, is placed on the top surface of the prepped bonded substrate and fusion bonded to the prepped bonded substrate, similar to the process 403 for the ICs. In some embodiments, the fusion bond creates a uniform or near-uniform material at the bonding surface between the bonded components, as described above. In some embodiments, after the process 407, the double-bonded substrate (e.g., the prepped bonded substrate and now-bonded microlens array 442) can be prepared for packaging in an optical device or optical component.

In some embodiments, the microlens array 442 is formed in or on a substrate, and/or is itself a substrate, that may have similar x- and y-dimensions to those of the bonded substrate. The bonded substrate may include dies for multiple photonic devices, and the microlens array 442 may include a series of microlenses and/or sub-arrays, each to be paired with turning elements of a photonic device. In embodiments, a wafer-to-wafer bonding process is performed to bond the microlens array 442 to the bonded substrate. In some embodiments, dicing may be performed after the bonding process to separate multiple dies of the bonded substrate. These may then be packaged into individual photonic devices in some embodiments.

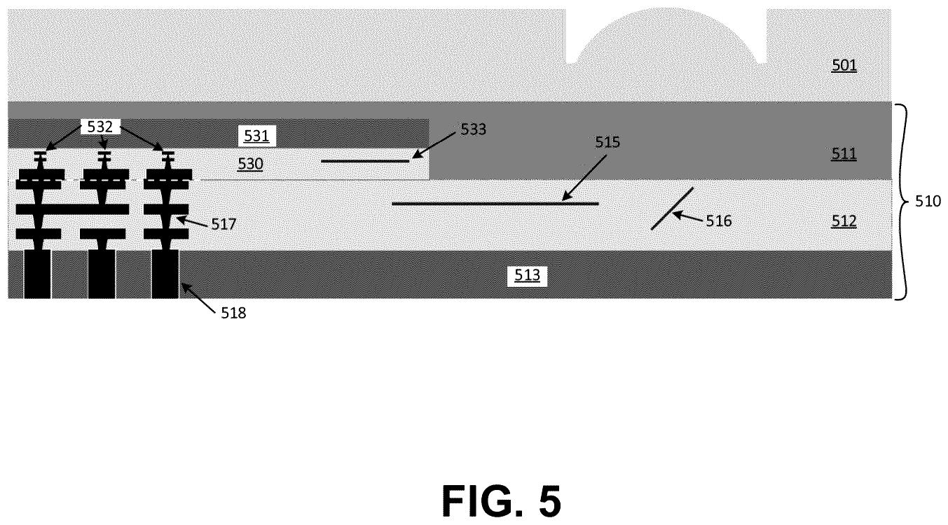

FIG. 5 is a side profile of a fusion bonded substrate 500, according to aspects of the disclosure. The substrate 500 includes a microlens array 501 that is fusion bonded to a bonded substrate 510. The bonded substrate includes a photonic integrated circuit (PIC) 530 embedded in gap-fill layer 511, a redistribution layer 512, and a base layer 513. It is noted that the illustrated fusion bonded substrate 500 may not be dimensionally accurate, but rather is used to functionally illustrate the various layers in the fusion bonded substrate 500. In particular, the height of the various layers may be compressed or expanded in order to show all layers in the same figure with relevant details.

The microlens array 501 can be the same as or similar to the microlens array 101 of FIG. 1. The redistribution layer 512 includes an optical path 515, photonic turning element 516, conductive vias/traces 517, and can be the same as or similar to the redistribution layer 112 of FIG. 1. The base layer 513 includes conductive vias/traces 518, and can be the same as or similar to the base layer 113 of FIG. 1.

The gap-fill layer 511 can be the same as or similar to the gap-fill layer 511 of FIG. 1, except that only the PIC 530 is included in the gap-fill layer 511, and there is no EIC (such as the EIC 120 described with reference to FIG. 1). The PIC 530 can be fusion bonded to the redistribution layer 512 in alignment with corresponding conductive vias/traces 517, as illustrated. The gap-fill layer 511 can subsequently be grown on top of and around the fusion bonded PIC 530. The PIC 530 can be the same as or similar to the PIC 130 described above with reference to FIG. 1, and can include the PIC substrate 531, conductive vias/traces 532, and an optical path 533.

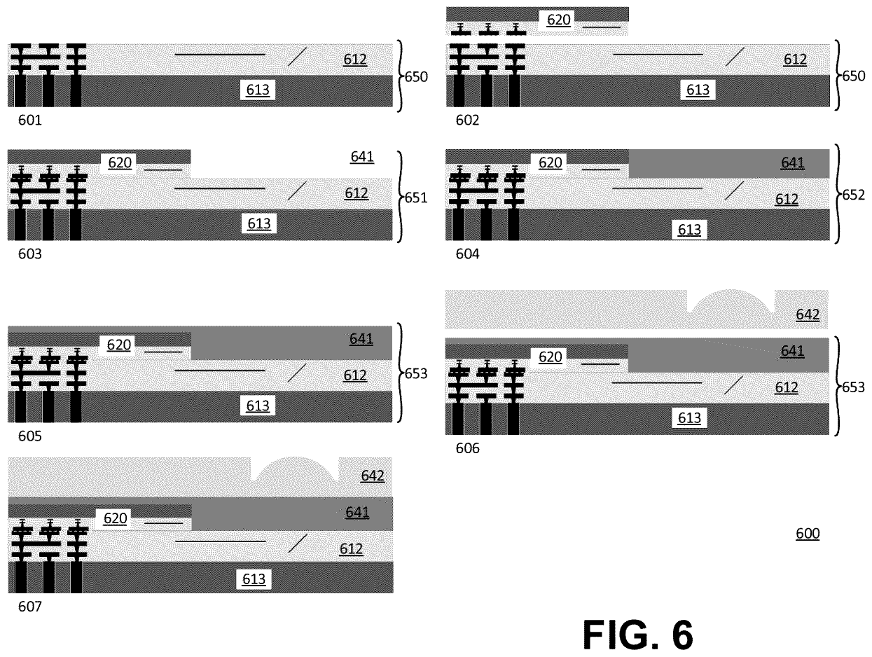

Additional details regarding the processes used to produce the fusion bonded substrate 500 are described below with reference to FIGS. 6-7.

FIG. 6 illustrates a workflow 600 for manufacturing wafer-level optical I/O components in a co-packaged optical device, according to some aspects of the disclosure. The workflow 600 may be performed using a series of manufacturing machines, such as semiconductor manufacturing machines. Examples of machines include etch reactors, deposition chambers, photolithography devices, metrology devices, bonding machines, and so on. The manufacturing machines may include hardware (e.g., one or more processing device(s), circuitry, dedicated logic, programmable logic, microcode, hardware of a device, integrated circuit, etc.), software (e.g., instructions run or executed on a processing device), or a combination thereof that cause the manufacturing machines to execute process recipes to perform operations that cause the co-packaged optical device to be manufactured. In one example, the workflow 600 is performed according to instructions from one or more controllers in a manufacturing environment. For example, the workflow 600 may be performed by multiple controllers, each associated with a respective manufacturing environment. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other workflows are possible.

Individual processes in the workflow 600 can be similar to respective process performed in the workflow 200 described with reference to FIG. 2. In some embodiments, the workflow 600 describes a series of processes used to produce the fusion bonded substrate 500 (e.g., photonic package or co-packaged optical device) of FIG. 5. The same features of the fusion bonded substrate 500 are illustrated in various processes of the workflow 600. Thus, descriptions of the functionality of elements or layers illustrated in the various processes of the workflow 600 can be found in the description above accompanying FIG. 5.

At process 601, an initial photonic substrate 650 is prepared for a fusion bonding process. The initial photonic substrate 650 can include a redistribution layer 612 and a base layer 613, such as redistribution layer 512 and base layer 513 of FIG. 5, respectively. In some embodiments, the process 601 includes a flattening operation (e.g., such as CMP) to create a uniform top surface of the initial photonic substrate 650. In some embodiments, the top surface of the initial photonic substrate 650 is cleaned during the process 601, immediately prior to the process 602.

At process 602, an integrated circuit (IC), here illustrated as a photonic integrated circuit (PIC 620) is aligned with the initial photonic substrate 650. In some embodiments features of the PIC 620 are aligned with corresponding features of the initial photonic substrate 650. For example, the conductive vias/traces of the PIC 620 can be aligned with corresponding conductive vias/traces of the initial photonic substrate 650. In some embodiments, one or more alignment features can be manufactured on the PIC 620 and/or the initial photonic substrate 650. The alignment features can be used to align the PIC 620 with the initial photonic substrate 650. In some embodiments, the top surface of the initial photonic substrate 650 is cleaned during the process 602, immediately prior to the process 603. This cleaning can improve the quality of the fusion bond created during the process 603.

At process 603, the IC (here a PIC 620) is placed on the top surface of the initial photonic substrate 650 and fusion bonded to the initial photonic substrate 650. In some embodiments, the fusion bond is a hybrid fusion bond (i.e., a fusion bond which allows conductive materials to bond to other conductive materials and semiconductive materials to bond to semiconductive materials). In some embodiments, the fusion bond creates a uniform or near-uniform material at the bonding surface between the bonded components (e.g., the conductive materials or the semiconductive materials). In some embodiments, the top surface of the initial photonic substrate 650 is cleaned during the process 603, immediately prior to the process 604.

At process 604, a gap-fill material is deposited onto the bonded substrate 651 (e.g., the initial photonic substrate 650 with the now-bonded PIC 620). A deposition process may form the gap-fill layer 641 over exposed regions of the photonic substrate and over the PIC 620. After the gap-fill material has reached a sufficient height, the bonded substrate is flattened to create a uniform top surface (e.g., by a CMP process). In some embodiments, the sufficient height of the gap-fill layer 641 is determined by a height of the PIC 620. That is, gap-fill material is deposited onto the bonded substrate until the bonded substrate can be polished to have a uniform top surface where the top surface of the gap-fill layer 641 is coplanar with a top surface of the PIC 620. In some embodiments, the top surface of the uniform bonded substrate is cleaned during the process 604, immediately prior to the process 605.

At process 605, the uniform bonded substrate 652 (e.g., the bonded substrate 651 having a uniform top surface) is prepared for a second fusion bonding process. In some embodiments, a thin layer of material can be deposited onto the uniform bonded substrate. The thin layer of material illustrated at process 605 can be the same as or similar to the material used for the gap-fill process at the process 604. In some embodiments, the thin layer of material is applied to the uniform bonded substrate in a way that facilitates the formation of a strong fusion bond when the passive photonic component is bonded to the uniform bonded substrate at the process 607. In one embodiment, the material is a semiconductor material. In some embodiments, the top surface of the prepped bonded substrate is cleaned during the process 605, immediately prior to the process 606.

At process 606, a passive photonic component, here illustrated as a microlens array 642, is aligned with the prepped bonded substrate 653 (e.g., the uniform bonded substrate 652 having a top surface prepped for fusion bonding), similar to the process 601 for the ICs. In some embodiments, one or more features of the microlens array 642 (or other passive photonic component) are aligned with corresponding one or more features of the prepped bonded substrate. For example, lenses of the microlenses array may be aligned with turning elements in the bonded substrate. The gap-fill layer 641 may be transparent to the wavelengths of light that are transmitted between the lenses and the turning element in embodiments. In some embodiments, one or more alignment features can be manufactured on the substrate containing the microlens array 642 and/or the prepped bonded substrate. The alignment features can be used to align the microlens array 642 with the prepped bonded substrate. In some embodiments, the top surface of the prepped bonded substrate is cleaned during the process 606, immediately prior to the process 607. This cleaning can improve the quality of the fusion bond created during the process 607.

At process 607, the passive photonic component, here the microlens array 642, is placed on the top surface of the prepped bonded substrate and fusion bonded to the prepped bonded substrate, similar to the process 603 for the PIC 620. In some embodiments, the fusion bond creates a uniform or near-uniform material at the bonding surface between the bonded components, as described above. In some embodiments, after the process 607, the double-bonded substrate (e.g., the prepped bonded substrate and now-bonded microlens array 642) can be prepared for packaging in an optical device or optical component.

In some embodiments, the microlens array 642 is formed in or on a substrate, and/or is itself a substrate, that may have similar x- and y-dimensions to those of the bonded substrate. The bonded substrate may include dies for multiple photonic devices, and the microlens array 642 may include a series of microlenses and/or sub-arrays, each to be paired with turning elements of a photonic device. In embodiments, a wafer-to-wafer bonding process is performed to bond the microlens array 642 to the bonded substrate. In some embodiments, dicing may be performed after the bonding process to separate multiple dies of the bonded substrate. These may then be packaged into individual photonic devices in some embodiments.

FIG. 7 illustrates a workflow 700 for manufacturing wafer-level optical I/O components in a co-packaged optical device, according to some aspects of the disclosure. The workflow 700 may be performed using a series of manufacturing machines, such as semiconductor manufacturing machines. Examples of machines include etch reactors, deposition chambers, photolithography devices, metrology devices, bonding machines, and so on. The manufacturing machines may include hardware (e.g., one or more processing device(s), circuitry, dedicated logic, programmable logic, microcode, hardware of a device, integrated circuit, etc.), software (e.g., instructions run or executed on a processing device), or a combination thereof that cause the manufacturing machines to execute process recipes to perform operations that cause the co-packaged optical device to be manufactured. In one example, the workflow 700 is performed according to instructions from one or more controllers in a manufacturing environment. For example, the workflow 700 may be performed by multiple controllers, each associated with a respective manufacturing environment. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other workflows are possible.

At operation 701, processing logic performing the workflow 700 causes a top surface of a photonic substrate to be leveled, such as by a CMP process. As illustrated in FIG. 7, the operation 701 may be performed multiple times during the workflow 700, that is, after each gap-fill process is performed on the photonic substrate.

At operation 702, the processing logic causes a top surface of the photonic substrate to be prepared for fusion-bonding, as described above with reference to processes 201, process 205, or process 209 of FIGS. 2A-2B. In some embodiments, a thin layer of material can be deposited onto the top surface of the photonic substrate. In some embodiments, the thin layer of material is applied in such a way that facilitates the formation of a strong fusion bond.

At operation 703, the processing logic determines whether there are integrated circuits (ICs) to bond to the photonic substrate. If there are ICs to bond to the photonic substrate, processing logic proceeds to the operation 704. If there are not ICs to bond to the photonic substrate, the processing logic proceeds to the operation 705.

At operation 704, responsive to the processing logic determining at the operation 703 that there are ICs to bond to the photonic substrate, the processing logic causes one or more ICs to be aligned with the photonic substrate. In some embodiments, one or more alignment features of an IC can be aligned with one or more alignment features of the photonic substrate. In some embodiments, alignment features can correspond to optical features such as optical couplers, and/or electrical features such as electrically conductive vias/traces/pads, or the like.

At operation 705, the processing logic causes the one or more ICs to be fusion bonded with the photonic substrate. In some embodiments, fusion bond is a hybrid fusion bond. In some embodiments, multiple ICs can be bonded to the same top surface concurrently.

At operation 706, the processing logic causes a gap-fill process to be performed on the photonic substrate. In some embodiments, a gap-fill material is deposited onto the bonded substrate (e.g., the photonic substrate with the now-bonded PIC). The gap-fill material is formed to be coplanar with the PIC. A deposition process may form the gap fill layer over exposed regions of the photonic substrate and over the PIC. For example, deposition processes may include one or more of chemical vapor deposition (CVD), physical vapor deposition (PVD), or atomic layer deposition (ALD).

After the operation 707, the processing logic returns back to the operation 701.

At operation 707, responsive to the processing logic determining at the operation 703 that there are not ICs to bond to the photonic substrate, the processing logic causes a microlens array substrate to be aligned with the photonic substrate.

At operation 708, the processing logic causes the microlens array substrate to be fusion bonded to the photonic substrate. In some embodiments the photonic substrate is hybrid fusion bonded to the microlens array substrate.

At operation 709, the processing logic causes the bonded photonic substrate (e.g., the photonic substrate and the now-bonded microlens array) to be prepared for photonic packaging, such as in an optical device or an optical component.

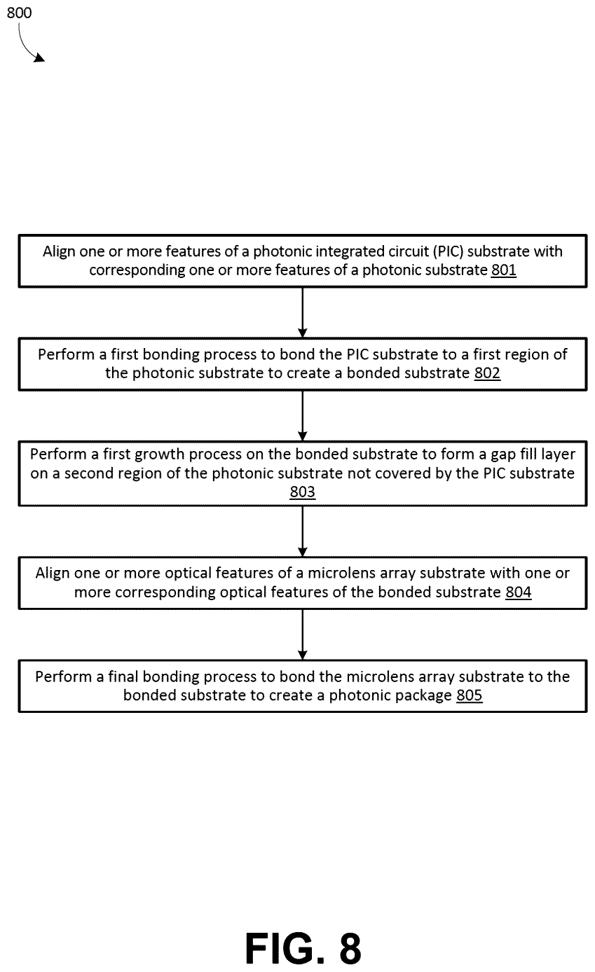

FIG. 8 illustrates a workflow 800 for manufacturing wafer-level optical I/O components in a co-packaged optical device, according to some aspects of the disclosure. The workflow 800 may be performed using a series of manufacturing machines, such as semiconductor manufacturing machines. Examples of machines include etch reactors, deposition chambers, photolithography devices, metrology devices, bonding machines, and so on. The manufacturing machines may include hardware (e.g., one or more processing device(s), circuitry, dedicated logic, programmable logic, microcode, hardware of a device, integrated circuit, etc.), software (e.g., instructions run or executed on a processing device), or a combination thereof that cause the manufacturing machines to execute process recipes to perform operations that cause the co-packaged optical device to be manufactured. In one example, the workflow 800 is performed according to instructions from one or more controllers in a manufacturing environment. For example, the workflow 800 may be performed by multiple controllers, each associated with a respective manufacturing environment. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some implementations. Thus, not all illustrated operations are required in every implementation, and other workflows are possible.

At operation 801, the processing logic aligns one or more features of a photonic integrated circuit (PIC) substrate with corresponding one or more features of a photonic substrate. In some embodiments, the photonic substrate includes multiple waveguides and multiple integrated turning elements. The waveguides can be configured to optically couple with respective integrated photonic turning elements. In some embodiments, the photonic substrate includes a plurality of photonic dies formed therein.

At operation 802, the processing logic performs a first bonding process to bond the PIC substrate to a first region of the photonic substrate to create a bonded substrate. In some embodiments, the PIC substrate includes multiple PIC dies formed therein. In some embodiments, each PIC die includes one or more waveguides configured to optically couple with corresponding waveguides in the photonic substrate. In some embodiments, each PIC die includes multiple electrical connections configured to electrically couple with corresponding electrical connections in the photonic substrate. In some embodiments, the first bonding process is a hybrid fusion bonding process.

At operation 803, the processing logic performs a first growth process on the bonded substrate to form a gap-fill layer on a second region of the photonic substrate not covered by the PIC substrate.

In some embodiments, prior to aligning the microlens array substrate in operation 804, the processing logic aligns one or more electrical features of an electrical integrated circuit (EIC) substrate with one or more corresponding electrical features of the bonded substrate. The processing logic performs a second bonding process to bond the EIC substrate to a first region of the bonded substrate to create an updated bonded substrate. The processing logic performs a second growth process on the updated bonded substrate to form a second gap-fill layer on a second region of the updated bonded substrate not covered by the EIC substrate. In some embodiments, the first gap-fill layer is coplanar with the PIC substrate. In some embodiments, the second gap-fill layer is coplanar with the EIC substrate. In some embodiments, the EIC substrate comprises a plurality of EIC dies formed therein. In some embodiments, each EIC die comprises multiple electrical connections configured to electrically couple with corresponding electrical connections in respective PIC dies in the PIC substrate.

At operation 804, the processing logic aligns one or more optical features of a microlens array substrate with one or more corresponding optical features of the bonded substrate.

At operation 805, the processing logic performs a final bonding process to bond the microlens array substrate to the bonded substrate to create a photonic package. In some embodiments, the final bonding process is a hybrid fusion bonding process.

FIG. 9 is a diagram of cross-sectional view of an example system 900, according to some aspects of the disclosure. As shown in FIG. 9, the system 900 can include an interposer substrate 910 of an interposer, a PIC substrate 920 of a PIC, and an optical fiber array connector 930 associated with an optical fiber array. The interposer substrate 910 and the PIC substrate 920 can be formed from any suitable material. In some embodiments, at least one of the interposer substrate 910 or the PIC substrate 920 is a silicon (Si) substrate.

In some embodiments, the system 900 can further include an optical interface, formed on the interposer substrate 910, between the PIC substrate 920 and the optical fiber array connector 930. The optical interface can include a cladding layer 940A formed on the interposer substrate. The cladding layer 940A can include any suitable dielectric material. In some embodiments, the cladding layer 940A is formed from an oxide material. For example, the cladding layer 940A can be formed from SiO₂. More specifically, the cladding layer 940A can be a thick cladding layer. The cladding layer 940A can have any suitable thickness. In some embodiments, the thickness of the cladding layer 940A ranges from about 5 μm to about 20 μm.

The cladding layer 940A can include multiple (e.g., an array of) small trenches. For example, a trench can be a micro-trench. Each trench of the cladding layer 940A can have a turning element 950 formed therein. Each turning element 950 may include a reflective material (e.g., metal reflector) formed within a respective trench of the cladding layer 940A (e.g., formed on an angled trench wall of a respective trench). In some embodiments, the turning element 950 is a mirror. For example, the turning element 950 can be an angled mirror formed along an angled sidewall of its corresponding trench.

Multiple parallel inner cores, including inner core 942A, can be formed within the cladding layer 940A to form multiple parallel waveguides, and each turning element can be coupled (e.g., edge coupled) to a respective inner core of the multiple parallel inner cores (e.g., the turning element 950 coupled to the inner core 942A). The multiple parallel inner cores, including the inner core 942A, can be formed from any suitable material. The multiple parallel inner cores, including the inner core 942A, can have a higher refractive index than the cladding layer 940A to form effective optical waveguides. In some embodiments, the inner core 942A is formed from Si₃N₄.

In some embodiments, the optical interface can further include an array of optical elements 960 formed on the thick cladding layer. The array of optical elements 960 can function as optical I/O to the optical fibers. For example, the array of optical elements 960 can collimate light to increase alignment tolerance. More specifically, each optical element of the array of optical elements 960 can direct and/or refocus light redirected by a respective turning element (e.g., reflected off a respective angled mirror) toward a respective optical fiber of an optical fiber array associated with the optical fiber array connector 930. The array of optical elements 960 can include any suitable optical elements and/or combinations of optical elements in accordance with embodiments described herein.

In some embodiments, the array of optical elements 960 is a 2D lens array. For example, the array of optical elements 960 can include one or more metalenses (e.g., an array of metalenses). A metalens is an ultra-thin, flat optical element that can focus or manipulate light. For example, a metalens can interact with light, altering its phase, amplitude, or polarization. By precisely controlling the shape, size, and arrangement of a metalens, the metalens can be designed to achieve various optical functions, such as focusing, beam shaping, creating holographic images, etc. Multiple metalenses can form a metalens array or stack on the backside of the PIC. A metalens can have sub-wavelength dimensions. In some embodiments, a metalens has a dimension that ranges from about 0.5 micrometer (μm) to about 2 μm. A metalens can be formed from any suitable material. The type of material can depend on a variety factors, such as target wavelength (visible light, infrared, etc.), efficiency, ease of fabrication, cost, etc. Examples of materials that can be used to form a metalens include silicon (Si), dielectric materials (e.g., titanium dioxide (TiO₂) and gallium nitride (GaN)), materials (e.g., silicon nitride (SiN) and zinc selenide (ZnSe)), phase-change materials (e.g., germanium-antimony-tellurium (GST) and vanadium dioxide (VO₂)), transition metal dichalcogenides (e.g., molybdenum disulfide (MoS₂), tungsten disulfide (WS₂), tungsten diselenide (WSe₂), molybdenum ditelluride (MoTe₂), rhenium disulfide (ReS₂)), carbon (C) (e.g., graphene), metals (e.g., gold (Au) and silver (Ag)), etc.

As another example, the array of optical elements 960 can include one or more microlenses (e.g., an array of microlenses). A microlens can have a sphere or hemisphere shape that can function based on similar principles as a traditional curved lens. A microlens can have a diameter typically less than 1 mm. In some embodiments, a microlens has a diameter that ranges from about 100 μm to about 200 μm. The small size of microlenses can enable microlenses to focus light onto specific points. Microlenses can be formed from polymers, glass or other suitable optical materials. The type of material can depend on a variety factors, such as target wavelength (visible light, infrared, etc.), application (imaging, sensing, light coupling, etc.) efficiency, ease of fabrication, cost, etc. Examples of polymers that can be used to form a microlens include polymethyl methacrylate (PMMA), polycarbonate (PC), epoxy, etc. Examples of glasses that can be used to form a microlens include Si, fused silica (SiO₂), chalcogenide glass, other optical glasses, etc.

In some embodiments, and as shown in FIG. 9, an additional cladding layer 940B is formed on the cladding layer 940A. The additional cladding layer 940B can include any suitable dielectric material. In some embodiments, the additional cladding layer 940B is formed from an oxide material. For example, the additional cladding layer 940B can be formed from SiO₂. The additional cladding layer 940B can have a smaller thickness than the cladding layer 940A.

Multiple inner cores (e.g., tapered inner cores) (e.g., inner core 942B) can be formed within the additional cladding layer 940B to form multiple waveguides (e.g., tapered waveguides). Each of the inner cores formed within the cladding layer 940B can be configured to enable evanescent wave coupling of an optical signal with respect to a respective inner core formed within the cladding layer 940A (e.g., evanescent wave coupling between the inner core 942A and the inner core 942B, as indicated by the arrow to the inner core 944). The inner core 942B can be formed from any suitable material. The material of the inner core 942B can have a higher refractive index than the additional cladding layer 940B to form an effective optical waveguide. In some embodiments, the inner core 942B is formed from Si₃N₄.

In some embodiments, the cladding layer 940B is hybrid bonded to the cladding layer 940A. Hybrid bonding refers to an advanced chip integration technique that combines both electrical and mechanical bonding at the wafer or die level. Hybrid bonding can allow for two components (e.g., wafers and/or chips) to be directly connected to each other by creating nanoscale interconnections, which can enable higher density, better performance, and lower power consumption as compared to traditional bonding techniques such as wire bonding, flip-chip bonding, etc.

In some embodiments, the minimum pitch of turning elements (e.g., in the vertical direction when viewing the interposer from a top-down view) can be determined based at least in part on a minimum optical fiber pitch. The number of columns of turning elements (e.g., in the horizontal direction when viewing the interposer from a top-down view) can be determined based at least in part by a minimum mirror width (e.g., process-defined), and the maximum optical waveguide density that can be routed between turning elements. Illustratively, for a 1D array of waveguides within the thick cladding layer, a 10 μm waveguide pitch within the thick cladding layer can be considered safe. For example, “safe” refers to the minimum safe distance between optical waveguides that ensures no unwanted optical coupling between adjacent waveguides. If the spacing were reduced below 10 μm, then there is greater probability for optical crosstalk between adjacent waveguides. Such a pitch can limit the maximum number of columns of turning elements to 11. Assuming a 127 μm pitch for the turning elements, a 200 gigabit/lane bandwidth, 11 columns of turning elements, and 7 turning elements per column within a 1 mm interposer shoreline, the maximum optical bandwidth density that can be achieved using the optical interface can be approximately 15.4 Tb/s/mm. Accordingly, optical interfaces described herein can achieve optical bandwidth densities that are greater than or equal to about 10 Tb/s/mm to match electrical bandwidth densities. Accordingly, the optical interface shown in FIG. 9 can be used to achieve optical bandwidth densities that are greater than or equal to about 10 Tb/s/mm to match electrical bandwidth densities.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set can be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., can be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments include at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, can be used. It should be understood that these terms may not be intended as synonyms for each other. Rather, in particular examples, “connected” or “coupled” can be used to indicate that two or more elements are in direct or indirect physical or electrical contact with each other. “Coupled” can also mean that two or more elements are not in direct contact with each other, but yet still co-operate or interact with each other.

Unless specifically stated otherwise, it can be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” can refer to any device or portion of a device that processes electronic data from registers and/or memory and transform that electronic data into other electronic data that can be stored in registers and/or memory. A “computing platform” can comprise one or more processors. As used herein, “software” processes can include, for example, software and/or hardware entities that perform work over time, such as tasks, threads, and intelligent agents. Also, each process can refer to multiple processes, for carrying out instructions in sequence or in parallel, continuously, or intermittently. In at least one embodiment, terms “system” and “method” are used herein interchangeably insofar as the system can embody one or more methods and methods can be considered a system.

In the present document, references can be made to obtaining, acquiring, receiving, or inputting analog or digital data into a subsystem, computer system, or computer-implemented machine. In at least one embodiment, the process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references can also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or inter-process communication mechanism.

Although descriptions herein set forth example embodiments of described techniques, other architectures can be used to implement described functionality, and are intended to be within the scope of this disclosure. Furthermore, although specific distributions of responsibilities can be defined above for purposes of description, various functions and responsibilities might be distributed and divided in different ways, depending on circumstances.

Furthermore, although the subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
aligning one or more features of a photonic integrated circuit (PIC) substrate with corresponding one or more features of a photonic substrate;
performing a first bonding process to bond the PIC substrate to a first region of the photonic substrate to create a bonded substrate;
performing a first growth process on the bonded substrate to form a first gap-fill layer on a second region of the photonic substrate not covered by the PIC substrate;
aligning one or more optical features of a microlens array substrate with one or more corresponding optical features of the bonded substrate; and
performing a final bonding process to bond the microlens array substrate to the bonded substrate to create a photonic package.

2. The method of claim 1, wherein the photonic substrate comprises a plurality of waveguides and a plurality of integrated photonic turning elements, wherein waveguides of the plurality of waveguides are configured to optically couple with respective integrated photonic turning elements of the plurality of integrated photonic turning elements.

3. The method of claim 1, wherein the photonic substrate comprises a plurality of photonic dies formed therein.

4. The method of claim 1, wherein the PIC substrate comprises a plurality of PIC dies formed therein.

5. The method of claim 4, wherein PIC dies of the plurality of PIC dies each comprise a one or more waveguides configured to optically couple with corresponding waveguides in the photonic substrate.

6. The method of claim 4, wherein PIC dies of the plurality of PIC dies each comprises a plurality of electrical connections configured to electrically couple with corresponding electrical connections in the photonic substrate.

7. The method of claim 1, further comprising performing the following prior to aligning the one or more optical features of the microlens array substrate with the one or more corresponding optical features of the bonded substrate:
aligning one or more electrical features of an electrical integrated circuit (EIC) substrate with one or more corresponding electrical features of the bonded substrate;
performing a second bonding process to bond the EIC substrate to a first region of the bonded substrate to create an updated bonded substrate; and
performing a second growth process on the updated bonded substrate to form a second gap-fill layer on a second region of the updated bonded substrate not covered by the EIC substrate.

8. The method of claim 7, wherein the first gap-fill layer is coplanar with the PIC substrate, and wherein the second gap-fill layer is coplanar with the EIC substrate.

9. The method of claim 7, wherein the EIC substrate comprises a plurality of EIC dies formed therein.

10. The method of claim 9, wherein EIC dies of the plurality of EIC dies each comprise a plurality of electrical connections configured to electrically couple with corresponding electrical connections in respective PIC dies of a plurality of PIC dies of the PIC substrate.

11. The method of claim 1, wherein the first bonding process is a fusion bonding process or a hybrid fusion bonding process.

12. The method of claim 1, further comprising performing the following prior to performing the first bonding process to bond the PIC substrate to the first region of the photonic substrate:
depositing a layer of dielectric material on a top surface of the photonic substrate in preparation for the first bonding process.

13. The method of claim 1, further comprising performing the following prior to aligning the one or more optical features of the microlens array substrate with the one or more corresponding optical features of the bonded substrate:
planarizing a top surface of the bonded substrate with a chemical mechanical planarization (CMP) process.

14. A photonic substrate comprising:
a plurality of photonic dies disposed on a base substrate;
a plurality of photonic integrated circuit (PIC) dies that are fusion bonded to respective photonic dies of the plurality of photonic dies disposed on the base substrate; and
a microlens array substrate that is fusion bonded to the plurality of PICs and the base substrate.

15. The photonic substrate of claim 14, further comprising:
a plurality of electrical integrated circuit (EIC) dies that are hybrid fusion bonded to respective photonic dies dies of the plurality of photonic dies, wherein the microlens array substrate is further fusion bonded to the plurality of EIC dies.

16. The photonic substrate of claim 14, wherein each photonic die of the plurality of photonic dies comprises a photonic waveguide, wherein each PIC of the plurality of PICs comprises a PIC waveguide, and wherein each PIC waveguide is evanescently coupled with a respective photonic waveguide.

17. The photonic substrate of claim 14, wherein a fusion bond permanently joins, with atomic bonds, a first portion of dielectric material in the one or more PIC dies to a second portion of dielectric material in the base substrate.

18. A photonic substrate comprising:
one or more photonic dies disposed on a base substrate;
one or more photonic integrated circuit (PIC) dies that are fusion bonded to respective photonic dies of the one or more photonic dies;
one or more electrical integrated circuit (EIC) dies that are hybrid fusion bonded to respective PIC dies of the one or more PIC dies; and
a microlens array substrate that is fusion bonded to the one or more EIC dies.

19. The photonic substrate of claim 18, wherein each photonic die of the plurality of photonic dies comprises photonic waveguide, wherein each PIC of the one or more PICs comprises a PIC waveguide, and wherein each PIC waveguide is evanescently coupled with a respective photonic waveguide.

20. The photonic substrate of claim 18, wherein a hybrid fusion bond permanently joins, with atomic bonds, a first portion of dielectric material in the one or more EIC dies to a second portion of dielectric material in the one or more PIC dies and a first portion of conductive material in the one or more EIC dies to a second portion of conductive material in the one or more PIC dies.
